(19) United States
(12) Patent Application Publication
(10) Pub. No.: US 2026/0050059 A1
(43) Pub. Date: Feb. 19, 2026

(54) Operating method of a detection radar and associated detection radar

(71) Applicant: THALES, Meudon (FR)

(72) Inventors: Philippe GOY, MERIGNAC (FR); Rodolphe COTTRON, MERIGNAC (FR); Yoan VEYRAC, MERIGNAC (FR); Mickaël RAOULT, MERIGNAC (FR)

(21) Appl. No.: 19/253,816

(22) Filed: Jun. 28, 2025

(30) Foreign Application Priority Data
Jun. 28, 2024 (FR) 2407050

(51) Int. Cl. G01S 7/02; G01S 13/26; G01S 13/524

(52) U.S. Cl. CPC G01S 7/024; G01S 13/26; G01S 13/5242; G01S 13/5246

(57) ABSTRACT

A method for operating a target-detection radar following a first radar mode and a second radar mode corresponding to Doppler modes, the method including the implementation of several recurrences of a signal emission/reception operation, each N-th recurrence of said operation including the following sub-operations: generation of two consecutive pulses associated with different radar modes and different emission directions, emission of the pulses in different frequency bands, the pulses associated with different radar modes are emitted using different polarizations, and reception in a common time window of the echoes of the pulses.

### REFERENCE TO RELATED APPLICATION

This application is a U.S. non-provisional application claiming the benefit of French Patent Application No. 24 07050 filed on Jun. 28, 2024, the contents of which are incorporated herein by reference in their entirety.

### TECHNICAL FIELD OF THE INVENTION

The present invention relates to a method for operating a detection radar. The present invention also relates to a detection radar implementing such a method.

The technical field of the invention is the management of the detection and identification time allotment by radar systems.

### BACKGROUND OF THE INVENTION

Traditionally, a radar system can be used in a “single-task” manner, meaning a single Doppler mode of operation throughout the mission. This is, for example, the case of a maritime surveillance mode (called “MMTI,” from the English “Maritime Moving Target Indicator”) or terrestrial (called “GMTI,” from the English “Ground Moving Target Indicator”) which is adapted to a given altitude and type of target.

Thus, the AIR mode allows the detection of aircraft while the GMTI land surveillance mode allows the detection of devices moving on a land surface and the MMTI maritime surveillance mode allows the detection of devices moving on a maritime surface.

This adaptation includes, for example, the use of a fixed space scanning logic, waveforms, and processing. In other words, in such a case, the frame does not vary over time, as long as the operator does not change the mission or mode. The time allotment is then associated only with this task and the technical tasks of radar self-calibration.

Radar operators have for many years sought to expand the employment spectrum of radar detection systems and demand that they become “multitasking.” For example, for the same radar system, it is advantageous to simultaneously have a maritime tactical situation (MMTI), aerial (called “AIR”), and possibly have weather conditions feedback. The radar system must then define the time allotment to allocate to each of the tasks to be performed.

Obviously, the more time there is allocated to a task, the more effective it will be, such as in terms of detection and/or discrimination capacity. The management and optimization of the time allotment thus appear crucial for new radar systems.

Traditionally, the radar system uses “short time” interleaving strategies (at the processing block scale) or “long time” (at the scan scale) to carry out its different tasks. A time allotment is allocated to each of these tasks based on a compromise of the performance of each function taken individually (refresh time, detection range, etc.).

The interleaving of radar blocks is then a technique that temporally schedules tasks that are not simultaneous.

To obtain simultaneous tasks, a known technique consists of decomposing the radar antenna system into several sub-networks and allocating a task to each of the sub-networks to perform what is called a colored emission. This operation is mainly found in MIMO-type radar systems (from the English “Multiple Input Multiple Output”).

The simultaneous emission of several orthogonal waveforms is thus carried out to color the space, that is, to associate a pair {sub-network, waveform} with a direction {azimuth-elevation}. The colored emission allows either to obtain a complete view of the environment by considerably reducing or improving the refresh time of a task or to perform several tasks simultaneously.

This decomposition of the antenna space into sub-networks and the colored emission are not necessarily available or desirable for all radar architectures. Indeed, such a type of emission can degrade the performance of a radar system, particularly in terms of range.

### SUMMARY OF THE INVENTION

The present invention aims to solve this problem and therefore propose a solution allowing the implementation of a multitasking radar system while using a refresh time equivalent to that of a single-task system. This then allows the radar system to be adapted to any architecture while preserving the system's performance.

Accordingly, the invention relates to a method for operating a target-detection radar following a first radar mode and a second radar mode corresponding to Doppler modes, the method including the implementation of several recurrences of a signal emission/reception operation, each N-the recurrence of said operation including the following sub-operations:
Generation of two consecutive pulses associated with different radar modes and different emission directions;
Emission of the pulses in different frequency bands, the pulses associated with different radar modes are emitted using different polarizations; and
Reception in a common time window of the echoes of the pulses.

According to other advantageous aspects of the invention, the radar includes one or more of the following characteristics, taken individually or according to all technically possible combinations:
During the reception sub-operation, echoes associated with different radar modes are distinguished by determining their polarizations.
The different emission and reception directions correspond to different sites that are defined in relation to a pointing direction.
The first radar mode corresponds to the AIR mode and the second radar mode corresponds to the mode chosen from the group including:
   GMTI;
   MMTI;
   AIR with a pointing direction different from the first mode.
The first radar mode and the second radar mode correspond to different Doppler modes.
The same repetition frequency Fr is chosen for the two radar modes, the duration of each recurrence thus being equal to 1/Fr.
The same frequency band is chosen in each recurrence for the pulses associated with the same radar mode.
The method further includes an operation of coherent processing of the echoes in each frequency band.
A repetition frequency Fr1 is chosen for the first radar mode and a repetition frequency Fr2 is chosen for the second radar mode, such that Fr1=kFr2, where k is an integer, the duration of each recurrence is equal to 1/Fr1.
The same frequency band is chosen in each recurrence for the pulses associated with the first radar mode; and
The same frequency band is chosen in each k-th recurrence for the pulses associated with the second radar mode.
The method further includes a preliminary operation of selecting a number M corresponding to an ambiguity rank to be processed in a beam of signals emitted/received by the radar, the number M varying between 0 and a maximum number of ambiguity ranks in the beam.
During the emission sub-operation of each N-th recurrence, at least one of the pulses, called the de-phased pulse, is emitted with a random phase associated with the number N.
During the reception sub-operation of each N-th recurrence, the de-phasing of the received echoes is compensated in the frequency band of the de-phased pulse by the random phase associated with the number N-M.
Each pulse is emitted with a random phase associated with the corresponding frequency band.
The reception sub-operation effectively compensates for the de-phasing of the received echoes in each frequency band, this being by means of the random phase associated with the number N-M and this frequency band.

The invention also relates to a target-detection radar including technical means configured to implement the method as defined above.

### BRIEF DESCRIPTION OF THE DRAWINGS

The invention will appear more clearly upon reading the following description, given solely by way of non-limiting example, and made with reference to the drawings wherein:

FIG. 1 is a schematic view of a detection radar according to the invention;

FIGS. 2 and 3 are schematic views illustrating different applications of the radar of FIG. 1;

FIG. 4 is a flowchart of a method for operating the radar of FIG. 1;

FIGS. 5-8 are different views that illustrate the implementation of the method depicted in FIG. 4.

### DETAILED DESCRIPTION OF THE INVENTION

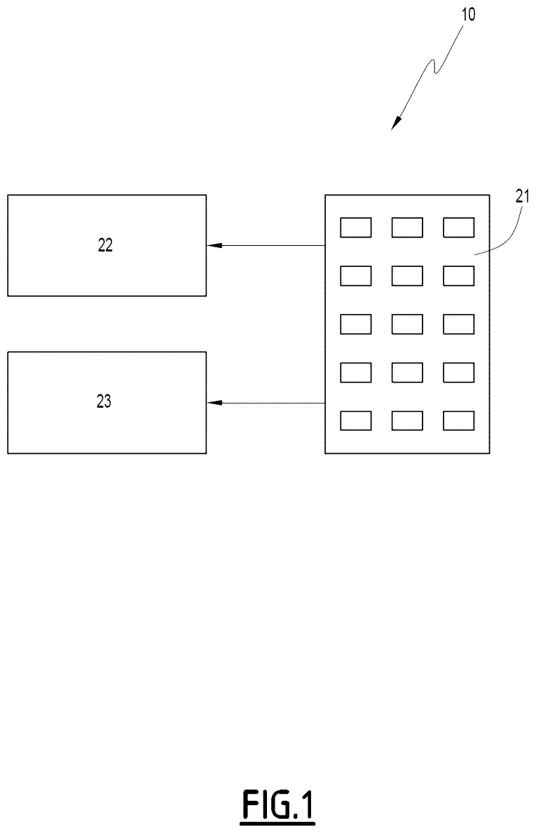

FIG. 1 illustrates a detection radar 10 according to the invention. This radar 10 is intended, for example, to be installed on a mobile carrier moving in the air and/or on a terrestrial surface and/or on a maritime surface. Advantageously, the radar 10 is intended to be embarked on a carrier moving in the air, such as an aircraft. Alternatively, the radar 10 is arranged in a fixed manner.

The radar 10 allows detecting targets following at least two radar modes. Each radar mode corresponds to a particular Doppler mode defining a waveform emitted towards a target.

By definition, the Doppler mode of a radar corresponds to a mode of operation of the latter in which Doppler-type processing is applicable.

In other words, each radar mode allows detecting targets of a particular type located or moving in a particular environment relative to the radar. For example, when the radar 10 is embarked on a carrier moving in the air, each radar mode allows detecting targets moving with a particular relative speed in the air or on a terrestrial or maritime surface.

Advantageously, the radar 10 allows detecting targets following at least two different radar modes.

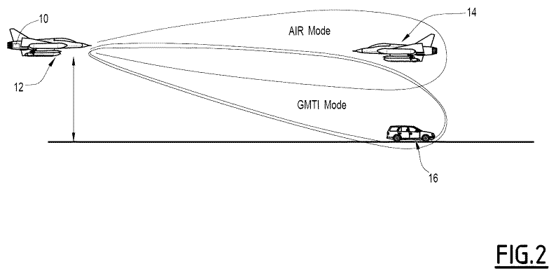

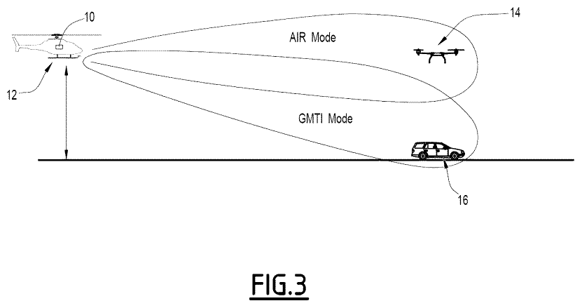

FIGS. 2 and 3 illustrate the implementation of a first radar mode called “AIR” and a second radar mode called “GMTI” when the radar 10 is embarked in an aircraft 12.

The AIR mode thus allows detecting other aircraft 14 moving near the aircraft 12. The pointing direction applied by the radar 10 in such a case is at a substantially zero site.

In the example of FIG. 2, the two aircraft 12, 14 are planes, such as combat planes, moving with a relative speed that may vary (for example from 0 to a few Mach numbers). In the example of FIG. 3, each aircraft 12, 14 is a helicopter or a drone so that their relative speed of movement is moderate or low (for example less than 200 km/h).

The GMTI mode allows detecting vehicles 16 (such as vehicles) moving on the terrestrial surface. Alternatively, the second radar mode may correspond to the MMTI mode to detect vehicles (such as boats) moving on a maritime surface. The pointing direction applied by the radar 10 in such a case is at a negative site.

Alternatively, the two modes implemented by the radar 10 are identical but correspond to different pointing directions. For example, the first mode may correspond to the “AIR” mode at positive sites and the second mode may correspond to the “AIR” mode at negative sites. A similar example with different pointing directions may also be applied to each of the GMTI and MMTI modes.

With reference to FIG. 1, the radar 10 includes an array of elementary antennas 21 allowing the emission of signals in the form of pulses and the reception of signals corresponding to echoes of these pulses.

The radar 10 further includes an emission unit 22 allowing the generation of pulses to be emitted by the antenna array 21 and a reception unit 23 allowing the processing of echoes received by the antenna array 21 to deduce the presence of a target and possibly, a speed and a distance to this target.

Each of the units 22 and 23 is made, for example, in the form of a programmable circuit of the FPGA type (from the English “Field Programmable Gate Array”) and/or of the ASIC type (from the English “Application-Specific Integrated Circuit”). In addition or alternatively, each of these units 22, 23 is made at least partially in the form of software executable by a processor and stored in a memory.

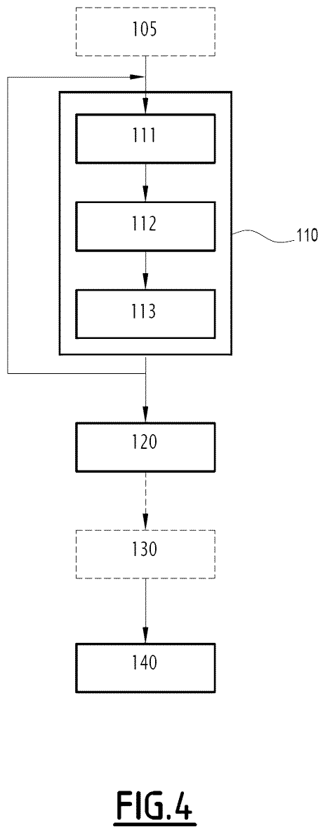

The method for operating the radar 10 will now be explained with reference to FIG. 4 presenting a flowchart of its operations.

It is considered that this method is implemented to perform a scan or an image of the surroundings of the carrier embarking the radar 10, according to, for example, a direction of movement of the carrier.

This method notably includes the implementation of several recurrences of a signal emission/reception operation 110.

The repetition frequency of these recurrences is chosen based on repetition frequencies associated with the radar modes. The repetition frequency of each radar mode is chosen based on the application chosen for the radar 10.

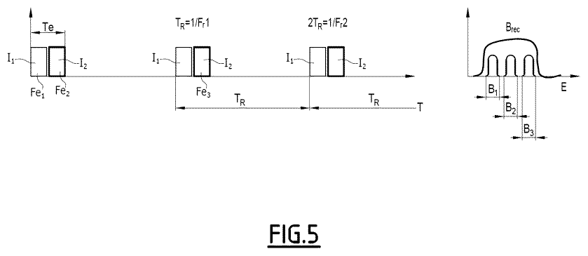

Thus, when the radar 10 is used according to the application explained with reference to FIG. 2 (i.e., speeds in “AIR” mode varying considerably), called the first application, a repetition frequency Fr1 is chosen for the first radar mode and a different repetition frequency Fr2 is chosen for the second radar mode. In such a case, it is considered that Fr1=kFr2, where k is an integer and therefore the first frequency Fr1 is greater than the second frequency Fr2. Moreover, in this application, the repetition frequency of each recurrence is chosen based on the greatest frequency, that is, based on Fr1. The duration T_{R} of each recurrence is then equal to 1/Fr1, as illustrated in FIG. 5.

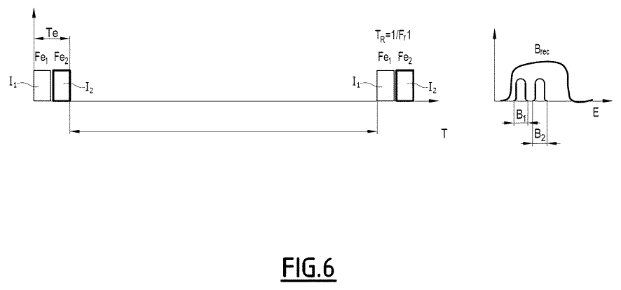

When the radar 10 is used according to the application explained with reference to FIG. 3 (i.e., variations in speeds in “AIR” mode are low or moderate), called the second application, the same repetition frequency Fr is chosen for the two radar modes. In such a case, this same repetition frequency Fr is chosen for each recurrence so that the duration T_{R} of each recurrence is equal to 1/Fr, as illustrated in FIG. 6.

Each N-th recurrence of operation 110 includes the implementation of sub-operations 111 to 113 explained in detail below.

During sub-operation 111, the emission unit 22 generates two consecutive pulses associated with different radar modes and different emission directions.

In particular, during this sub-operation, the emission unit 22 generates a first pulse I₁ associated with the first radar mode and a second pulse I₂ associated with the second radar mode.

Each pulse is associated with an emission direction defined, for example, by a pair of angular values. These angular values correspond, for example, to the elevation (or site) and azimuth of emission, denoted hereafter respectively by Elᵢ and Azᵢ. In all that follows, the index i=1 designates the first radar mode and i=2 designates the second radar mode.

The pulses are generated in an emission window Te wherein each pulse has a width Li and is spaced from the other pulse and from one of the boundaries of the emission window Te by a time gap T_{GAP}.

In the frequency domain, the pulses share the same frequency support B_{rec}, with a frequency gap F_{GAP} between the corresponding carriers Fi greater than the frequency bands Bi of these pulses. The frequency gap F_{GAP} is chosen sufficient to distinguish the echoes of these pulses upon reception. In all that follows, a frequency band is defined by a central frequency and a bandwidth. Advantageously, hereafter, all frequency bands have the same width. Moreover, the frequency gap F_{GAP} is measured between a pair of corresponding central frequencies and is greater than the width of each frequency band.

The frequency band B₁ of the first pulse I₁, that is, the pulse associated with the first radar mode (AIR mode), is chosen the same for each recurrence. Advantageously, this choice is independent of the application of the radar 10. This is schematically illustrated in FIGS. 5 and 6 illustrating several consecutive recurrences respectively of the first application and the second application of the radar 10. Thus, the same central frequency Fe₁ is chosen for the first pulse in each recurrence in each application.

The frequency band of the second pulse I₂, that is, the pulse associated with the second radar mode (GMTI or MMTI mode, for example), is chosen based on the application of the radar 10.

In particular, for the first application, the same frequency band and more particularly the same central frequency for the second pulse I₂ is chosen in each k-th recurrence. This technique may be seen as a barrel mechanism, where at each instant T_{R}, a central frequency is chosen in the barrel modulo k. In other words, in such a case, k different central frequencies are chosen alternately for the second pulses I₂ in k consecutive recurrences. In the example of FIG. 5, when k=2, two frequency bands B₂ and B₃ (i.e., two central frequencies) are then chosen alternately for each second pulse I₂.

For the second application, the same frequency band B₂ for the second pulse I₂ is chosen in each recurrence, as illustrated in FIG. 6.

During sub-operation 112, the emission unit 22 emits the pulses generated during the previous sub-operation in the corresponding frequency bands.

During sub-operation 113, the reception unit 23 receives echoes corresponding to the emitted pulses in a common reception time window. The duration of this common reception window is equal to the total duration of the recurrence T_{R} minus the duration of the emission window Te. During reception, echoes corresponding to different pulses are distinguished by their different frequency bands, using, for example, band-pass filters. A spatial filtering of the FFC type may also be applied in the direction associated with said band.

During a subsequent operation 120, implemented after the N recurrences of operation 110, the reception unit 23 implements a coherent processing of the echoes corresponding to the pulses associated with the first radar mode and the pulses associated with the second radar mode. The coherent processing consists of applying filtering adapted to the waveform of the detection mode, such as pulse compression on the short time axis (within a recurrence) and Doppler processing on the long time axis (from recurrence to recurrence).

During a subsequent operation 130, implemented only when the radar 10 operates according to its first application, the reception unit 23 further implements a non-coherent processing at the outputs of the coherent processing of the pulses associated with the second radar mode.

Such non-coherent processing performs the power averaging of the signals received on each frequency band of the same direction (after coherent processing).

In some embodiments, this operation is systematically implemented (i.e., regardless of the radar application) as long as k=1 the average is directly the signal.

During a subsequent operation 140, the reception unit 23 transmits all the outputs of the coherent processing and possibly the non-coherent processing, to any interested system allowing, for example, the implementation of a distance and/or speed ambiguity resolution.

These outputs may then be used to detect one or more targets according to the different radar modes, possibly with speeds and distances associated with these targets.

In some embodiments, the operating method as explained above further includes the implementation of at least one technique allowing the separation of the different radar modes and/or the rejection of certain echoes that are not necessary or are ambiguous in distance to reconstruct a complete image of the surroundings according to at least one of the radar modes.

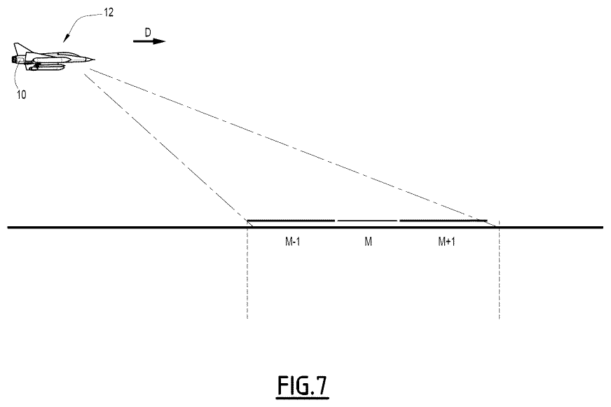

FIG. 7 illustrates an example of such a case according to the GMTI radar mode. According to this example, the radar beam emitted by the radar 10 from the carrier 12 covers on the terrestrial surface several portions whose echoes overlap as the carrier moves in direction D. To avoid processing all the echoes coming from the beam footprint on the ground, a first technique consisting of choosing and processing only one ambiguity rank within the beam is implemented.

According to this first technique, the operating method of the radar 10 further includes a preliminary operation 105 consisting of selecting a number M corresponding to an ambiguity rank to be processed in the beam of signals emitted/received by the radar. This number M then varies between 0 and a maximum number of ambiguity ranks in the beam. The maximum number depends notably on the opening of the radar beam. As illustrated in FIG. 7, the ambiguity rank M may correspond to the central part of the radar beam.

In some embodiments, during this operation, several numbers M corresponding to several ambiguity ranks to be processed are chosen. In this case, it is considered hereafter that the technique described below is applied in relation to each chosen number M. The processing is carried out, for example, in parallel.

During the implementation of the N-th recurrence of operation 110, and notably during the emission sub-operation 112, the emission unit 22 chooses one of the pulses, for example, the first pulse and adds a random phase to that pulse. Advantageously, the emission unit 22 adds a different random phase to each of the pulses. The or each pulse having a random phase added is hereafter called the de-phased pulse.

It should be noted that the choice of the pulse to be de-phased remains the same for each recurrence of this sub-operation 112. In other words, when only one pulse is de-phased during this sub-operation, the same pulse is de-phased in each recurrence of this operation. When both pulses are de-phased during this sub-operation, these pulses are also de-phased in each recurrence of this sub-operation.

It should also be noted that the value of the random phase ϕ_{¿} for the or each pulse is then memorized for at least M following recurrences of operation 110.

It should be noted further that when this first technique is implemented, the echoes received during the first P recurrences, called “dead time,” are, for example, rejected. This number P is related to the maximum instrumented distance, to the maximum delay from the most distant echo that the waveform may reach. The number P is therefore related to the maximum ambiguity rank of the radar mode, it is therefore a majorant of M: M≤P.

Then, during the reception sub-operation 113 the reception unit 23 compensates for the de-phasing of the received echoes in the frequency band of the de-phased pulse or each de-phased pulse, being by means of the random phase associated with the number N-M. In other words, de-phasing is implemented by subtracting the value ϕ_{¿-M} in the band corresponding to index i.

Thus, during the subsequent processing only the echoes corresponding to the ambiguity rank M may be processed coherently. The de-phasing of other echoes cannot be done correctly so that they are considered as white noise.

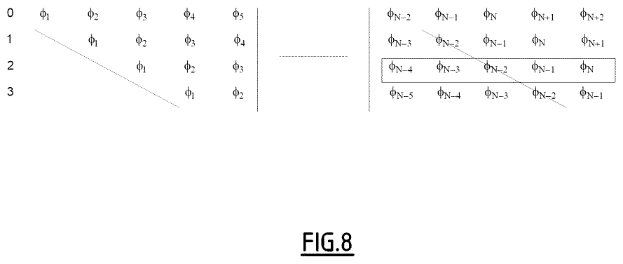

This principle is schematically illustrated in FIG. 8. According to the example of this figure, the number M is equal to 2 and the maximum number of ambiguity ranks is equal to 3. Thus, during the N-th recurrence of operation 110, to choose only the signals corresponding to the ambiguity rank M=2, the value ϕ_{¿-2} is used to compensate for the de-phasing in the corresponding frequency band.

Other techniques for resolving ambiguities in distance and speed and/or according to at least one pointing direction are possible, such as by using several repetition frequencies associated with extraction processing.

Additionally, it is possible to obtain better isolation of the echoes corresponding to the different radar modes during their reception.

Thus, according to a second technique, during the implementation of the N-th recurrence of operation 110, and particularly during the emission sub-operation 112, the emission unit 22 implements different slopes of the chirps used to emit the pulses associated with the different radar modes. In other words, during this sub-operation 112 the emission unit 22 emits the pulses using either an ascending slope or a descending slope depending on the radar mode associated with each pulse. The same slope is then used for all pulses of this type in all recurrences of operation 110.

For example, for all recurrences an ascending slope is chosen for the pulses associated with the first mode and a descending slope is chosen for the pulses associated with the second mode.

Then, during the reception sub-operation 113 the reception unit 23 receives echoes having different frequency slopes. This reception unit 23 therefore determines the received slopes (particularly using adapted filters) to isolate the echoes corresponding to the different radar modes.

According to a third technique, which also makes it possible to more fully isolate the echoes corresponding to the different radar modes during their reception, during the implementation of the N-th recurrence of operation 110 and particularly during the emission sub-operation 112, the emission unit 22 implements different polarizations of the waves used to emit the pulses associated with the different radar modes. In other words, during this sub-operation 112 the emission unit 22 emits the wave carrying each pulse with a polarization chosen based on the radar mode associated with this pulse. This same polarization is chosen for this type of pulse for all recurrences of operation 110.

For example, two polarizations, namely a vertical polarization and a horizontal polarization may be chosen for the pulses emitted during the emission sub-operation 112. According to other examples, a 45° or circular polarization may be used. For example, a left circular polarization may be associated with the AIR mode and a right circular polarization may be associated with the GMTI or MMTI mode.

Then, during the reception sub-operation 113, the reception unit 23 receives echoes having different polarizations. This reception unit 23 therefore determines the polarizations of the received echoes (particularly using adapted filters) to isolate the echoes corresponding to the different radar modes.

In some embodiments, the aforementioned techniques are combined with each other to be implemented simultaneously. Moreover, a technique for resolving ambiguities in distance and speed and/or according to at least one pointing direction may also be used in combination with the second technique or the third technique as described above.

It is then understood that the present invention presents a number of advantages.

First of all, the invention allows processing the two radar modes simultaneously, which allows operating with a common refresh time and this in each radar application. This presents a certain advantage for target tracking type processing.

Moreover, a modern radar architecture allows the use of a particular configuration (frequency, direction) of each pulse in the emission window Te.

The simultaneous processing of the two modes also presents an advantage in terms of detection and false alarm management. For example, usually, an AIR mode presents on its detection maps echoes present in its secondary lobes in the site. A SLS type processing (from the English “Side Lobe Suppression”) may then be used to filter these echoes so as to avoid detections of mobile targets present on the ground. On the contrary, in the context of simultaneous AIR and GMTI (or MMTI) modes this information may be useful as a means to correlate any targets detected in the secondary lobes present in one mode so as to send them to the other.

Moreover, the technique of choosing the desired ambiguity rank(s) makes it possible to retain only the signals corresponding to this or these ranks, thereby avoiding unnecessary processing. This technique also allows the addition of strong isolation between the signals of the AIR mode and the signals of the GMTI (or MMTI) mode.

Other techniques that facilitate the resolution of ambiguities in distance and speed and/or according to particular directions may also be employed, such as by using several repetition frequencies associated with an extraction processing.

1. A method for operating a target-detection radar following a first radar mode and a second radar mode corresponding to Doppler modes, the method comprising several recurrences of signal emission/reception, each recurrence comprising:
generating two consecutive pulses associated with different radar modes and different emission directions;
emitting the pulses in different frequency bands, the pulses associated with different radar modes being emitted using different polarizations; and
receiving in a common time window echoes of the pulses.

2. The method according to claim 1, wherein during said receiving, echoes associated with different radar modes are distinguished by determining their polarizations.

3. The method according to claim 1, wherein the different emission and reception directions correspond to different sites that are defined in relation to a pointing direction.

4. The method according to claim 1, wherein the first radar mode corresponds to an AIR mode and the second radar mode corresponds to a mode chosen from the group consisting of:
GMTI,
MMTI, and
AIR with a pointing direction different from the first mode.

5. The method according to claim 1, wherein the first and second radar modes correspond to different Doppler modes.

6. The method according to claim 1, wherein the same repetition frequency Fr is chosen for the two radar modes, the duration of each recurrence thus being equal to 1/Fr.

7. The method according to claim 6, wherein the same frequency band is chosen in each recurrence for the pulses associated with the same radar mode.

8. The method according to claim 6, further comprising coherently processing the echoes in each frequency band.

9. The method according to claim 1, wherein a repetition frequency Fr1 is chosen for the first radar mode and a repetition frequency Fr2 is chosen for the second radar mode, such that Fr1=kFr2, where k is an integer, the duration of each recurrence being equal to 1/Fr1.

10. The method according to claim 9, wherein:
the same frequency band is chosen in each recurrence for the pulses associated with the first radar mode; and
the same frequency band is chosen in each k-th recurrence for the pulses associated with the second radar mode.

11. The method according to claim 9, further comprising:
coherently processing the echoes corresponding to the pulses associated with the first and second radar modes; and
non-coherently processing outputs of the coherent processing of the echoes corresponding to the pulses associated with the second radar mode.

12. A target-detection radar implementing the method according to claim 1.
